(19) United States
(12) Patent Application Publication
(10) Pub. No.: US 2022/0014551 A1
(43) Pub. Date: Jan. 13, 2022

(54) METHOD AND APPARATUS TO REDUCE RISK OF DENIAL OF SERVICE RESOURCE ACQUISITION ATTACKS IN A DATA CENTER

(71) Applicant: Intel Corporation, Santa Clara, CA (US)

(72) Inventors: Saravanapriya RAMANATHAN, Portland, OR (US); Reshma LAL, Portland, OR (US)

(21) Appl. No.: 17/484,103

(22) Filed: Sep. 24, 2021

(51) Int. Cl. H04L 29/06

(52) U.S. Cl. CPC H04L 63/1458; H04L 63/20

(57) ABSTRACT

A policy based mechanism that enforces use of compute resources in a data center by authorized entities is provided. The policies include a set of policies associated with a requestor of compute resources and a set of policies associated with the use of resources in the data center. The policies are stored in a tamper proof way in a secure storage in the data center.

### FIELD

This disclosure relates to disaggregated computing and in particular to reduce risk of Denial of Service (DoS) resource acquisition attacks in a data center.

### BACKGROUND

Cloud computing provides access to servers, storage, databases, and a broad set of application services over the Internet. A cloud service provider offers cloud services such as network services and business applications that are hosted in servers in one or more data centers that can be accessed by companies or individuals over the Internet. Hyperscale cloud-service providers typically have hundreds of thousands of servers. Each server in a hyperscale cloud includes storage devices to store user data, for example, user data for business intelligence, data mining, analytics, social media and micro-services. The cloud service provider generates revenue from companies and individuals (also referred to as tenants) that use the cloud services.

Disaggregated computing or Composable Disaggregated Infrastructure (CDI) is an emerging technology that makes use of high bandwidth, low-latency interconnects to aggregate compute, storage, memory, and networking fabric resources into shared resource pools that can be provisioned on demand.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a simplified diagram of at least one embodiment of a data center for executing workloads with disaggregated resources;

FIG. 2 is a simplified diagram of at least one embodiment of a pod that may be included in a data center;

FIG. 3 is a simplified block diagram of at least one embodiment of a top side of a node;

FIG. 4 is a simplified block diagram of at least one embodiment of a bottom side of a node;

FIG. 5 is a simplified block diagram of at least one embodiment of a compute node;

FIG. 6 is a simplified block diagram of at least one embodiment of an accelerator node usable in a data center;

FIG. 7 is a simplified block diagram of at least one embodiment of a storage node usable in a data center;

FIG. 8 is a simplified block diagram of at least one embodiment of a memory node usable in a data center;

FIG. 9 depicts a system for executing one or more workloads;

FIG. 10 illustrates a compute node that includes an IPU and an xPU;

FIG. 11 is a simplified block diagram of a system that includes a secure orchestrator and the compute node shown in FIG. 10;

FIG. 12 illustrates an embodiment of a policy based mechanism that enforces use of compute resources in a data center by authorized entities;

FIG. 13 illustrates types of policies that can be stored in policies in secure storage;

FIG. 14 is an example of the resource management table in the orchestrator server used by the policy manager;

FIG. 15 is a flowgraph of a method performed by the policy owner to initialize policies for requestors and resources in the system shown in FIG. 12;

FIG. 16 is a flowgraph of a method performed to authenticate a requestor and assign a resource to the requestor.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DESCRIPTION OF EMBODIMENTS

Services abstraction such as microservices and Functions as a Service (FaaS) or Serviceless are driving loosely coupled, dynamically orchestrated services which require partitioning of compute or XPU and standardizing services allowing for Backend as a Service (BaaS). An XPU or xPU can refer to a graphics processing unit (GPU), general purpose GPU (GPGPU), field programmable gate array (FPGA), Accelerated Processing Unit (APU), accelerator or other processor. These can also include functions such as quality of service enforcement, tracing, performance and error monitoring, logging, authentication, service mesh, data transformation, etc. With massive levels of data processing, data may not be stored local to compute and processing requirements can exceed single XPU scale. These are driving a growth in the communication between services.

Cloud service providers (CSPs) are evolving their hardware platforms by offering central processing units (CPUs), general purpose graphics processing units (GPGPUs), custom XPUs, and pooled storage and memory (for example, DDR, persistent memory, 3D XPoint, Optane, or memory devices that use chalcogenide glass). CSPs are vertically integrating these with custom orchestration control planes to expose these as services to users.

In a disaggregated computing environment, it is of utmost importance to ensure that the data center is up and running at all times. When an application is compromised, an attacker could potentially perform mass acquisition of resources causing resource starvation and Denial of Service (DoS) to legitimate requests which could result in a CSP unable to meet a Service Level Agreement (SLA) with users and loss of revenue.

A policy based mechanism that enforces use of compute resources in a data center by authorized entities is provided. Policies are stored in a tamper proof way in a secure storage device in the data center. The policies include a set of policies associated with a requestor of compute resources and a set of policies associated with the use of resources in the data center. The policy based mechanism reduces risk of a rogue application taking over resources in the data center and denying service to other users of the data center.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

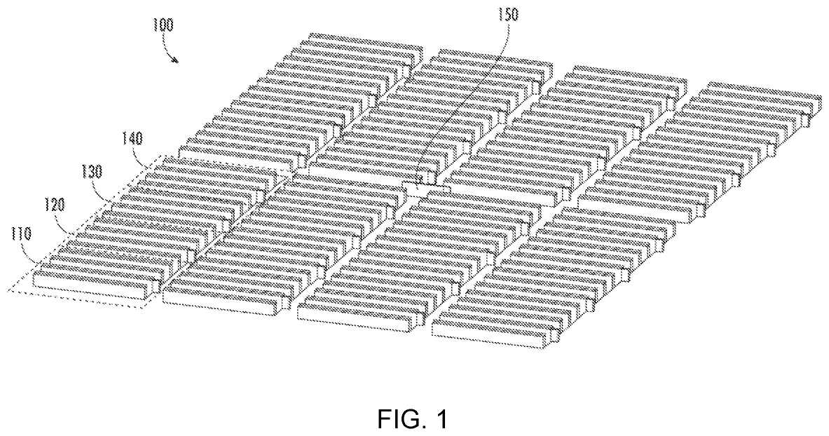

FIG. 1 depicts a data center 100 in which disaggregated resources may cooperatively execute one or more workloads (for example, applications on behalf of users (customers)) that includes multiple pods 110, 120, 130, 140, a pod being or including one or more rows of racks. Of course, although data center 100 is shown with multiple pods, in some embodiments, the data center 100 may be embodied as a single pod. As described in more detail herein, each rack houses multiple nodes, some of which may be equipped with one or more type of resources (for example, memory devices, data storage devices, accelerator devices, general purpose processors). Resources can be logically coupled to form a composed node or composite node, which can act as, for example, a server to perform a job, workload or microservices. In the illustrative embodiment, the nodes in each pod 110, 120, 130, 140 are connected to multiple pod switches (for example, switches that route data communications to and from nodes within the pod). The pod switches, in turn, connect with spine switches 150 that switch communications among pods (for example, the pods 110, 120, 130, 140) in the data center 100. In some embodiments, the nodes may be connected with a fabric using Intel® Omni-Path technology. In other embodiments, the nodes may be connected with other fabrics, such as InfiniBand or Ethernet or PCI Express or direct optical interconnect. As described in more detail herein, resources within nodes in the data center 100 may be allocated to a group (referred to herein as a “managed node”) containing resources from one or more nodes to be collectively utilized in the execution of a workload. The workload can execute as if the resources belonging to the managed node were located on the same node. The resources in a managed node may belong to nodes belonging to different racks, and even to different pods 110, 120, 130, 140. As such, some resources of a single node may be allocated to one managed node while other resources of the same node are allocated to a different managed node (for example, one processor assigned to one managed node and another processor of the same node assigned to a different managed node).

A data center comprising disaggregated resources, such as data center 100, can be used in a wide variety of contexts, such as enterprise, government, cloud service provider, and communications service provider (for example, Telcos), as well in a wide variety of sizes, from cloud service provider mega-data centers that consume over 60,000 sq. ft. to single- or multi-rack installations for use in base stations.

The disaggregation of resources to nodes comprised predominantly of a single type of resource (for example, compute nodes comprising primarily compute resources, memory nodes containing primarily memory resources), and the selective allocation and deallocation of the disaggregated resources to form a managed node assigned to execute a workload improves the operation and resource usage of the data center 100 relative to typical data centers comprised of hyperconverged servers containing compute, memory, storage and perhaps additional resources in a single chassis. For example, because nodes predominantly contain resources of a particular type, resources of a given type can be upgraded independently of other resources. Additionally, because different resource types (processors, storage, accelerators, etc.) typically have different refresh rates, greater resource utilization and reduced total cost of ownership may be achieved. For example, a data center operator can upgrade the processors throughout their facility by only swapping out the compute nodes. In such a case, accelerator and storage resources may not be contemporaneously upgraded and, rather, may be allowed to continue operating until those resources are scheduled for their own refresh. Resource utilization may also increase. For example, if managed nodes are composed based on requirements of the workloads that will be running on them, resources within a node are more likely to be fully utilized. Such utilization may allow for more managed nodes to run in a data center with a given set of resources, or for a data center expected to run a given set of workloads, to be built using fewer resources.

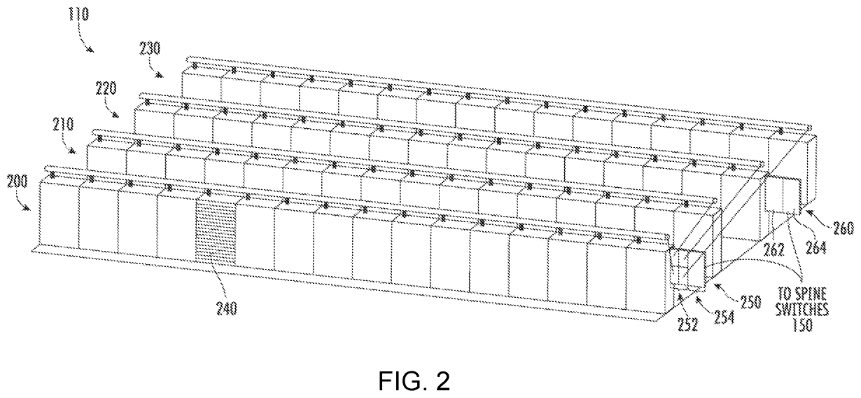

FIG. 2 depicts the pod 110 in data center 100. The pod 110 can include a set of rows 200, 210, 220, 230 of racks 240. Each rack 240 may house multiple nodes (for example, sixteen nodes) and provide power and data connections to the housed nodes, as described in more detail herein. In the illustrative embodiment, the racks in each row 200, 210, 220, 230 are connected to multiple pod switches 250, 260. The pod switch 250 includes a set of ports 252 to which the nodes of the racks of the pod 110 are connected and another set of ports 254 that connect the pod 110 to the spine switches 150 to provide connectivity to other pods in the data center 100. Similarly, the pod switch 260 includes a set of ports 262 to which the nodes of the racks of the pod 110 are connected and a set of ports 264 that connect the pod 110 to the spine switches 150. As such, the use of the pair of switches 250, 260 provides an amount of redundancy to the pod 110. For example, if either of the switches 250, 260 fails, the nodes in the pod 110 may still maintain data communication with the remainder of the data center 100 (for example, nodes of other pods) through the other switch 250, 260. Furthermore, in the illustrative embodiment, the switches 150, 250, 260 may be embodied as dual-mode optical switches, capable of routing both Ethernet protocol communications carrying Internet Protocol (IP) packets and communications according to a second, high-performance link-layer protocol (for example, PCI Express or Compute Express Link) via optical signaling media of an optical fabric.

It should be appreciated that each of the other pods 120, 130, 140 (as well as any additional pods of the data center 100) may be similarly structured as, and have components similar to, the pod 110 shown in and described in regard to FIG. 2 (for example, each pod may have rows of racks housing multiple nodes as described above). Additionally, while two pod switches 250, 260 are shown, it should be understood that in other embodiments, each pod 110, 120, 130, 140 may be connected to a different number of pod switches, providing even more failover capacity. Of course, in other embodiments, pods may be arranged differently than the rows-of-racks configuration shown in FIGS. 1-2. For example, a pod may be embodied as multiple sets of racks in which each set of racks is arranged radially, for example, the racks are equidistant from a center switch.

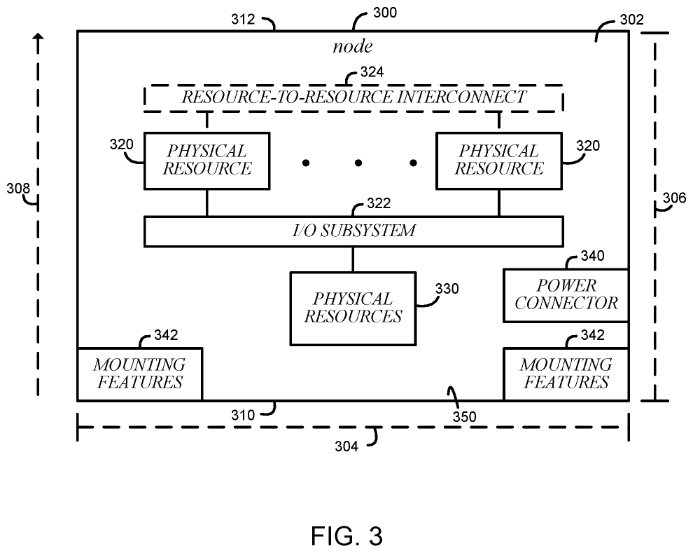

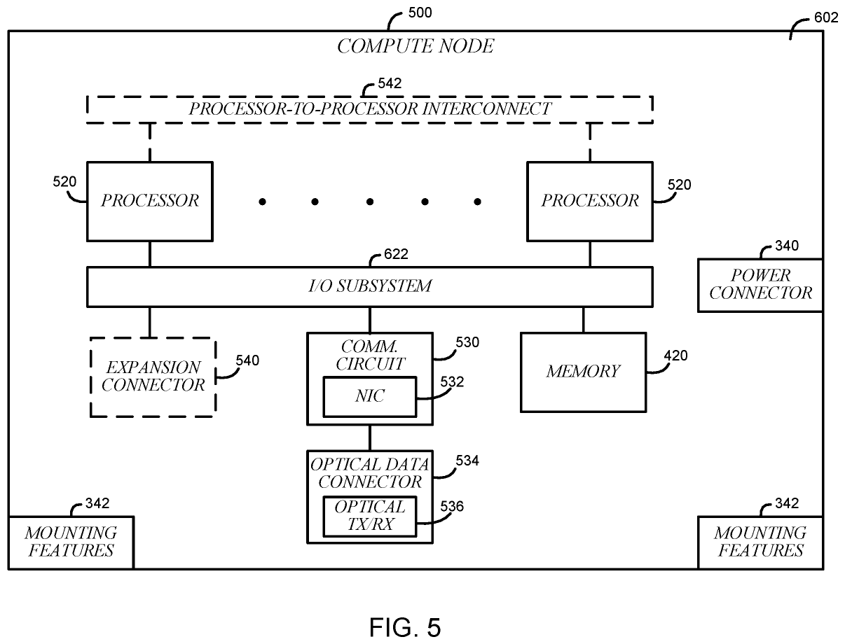

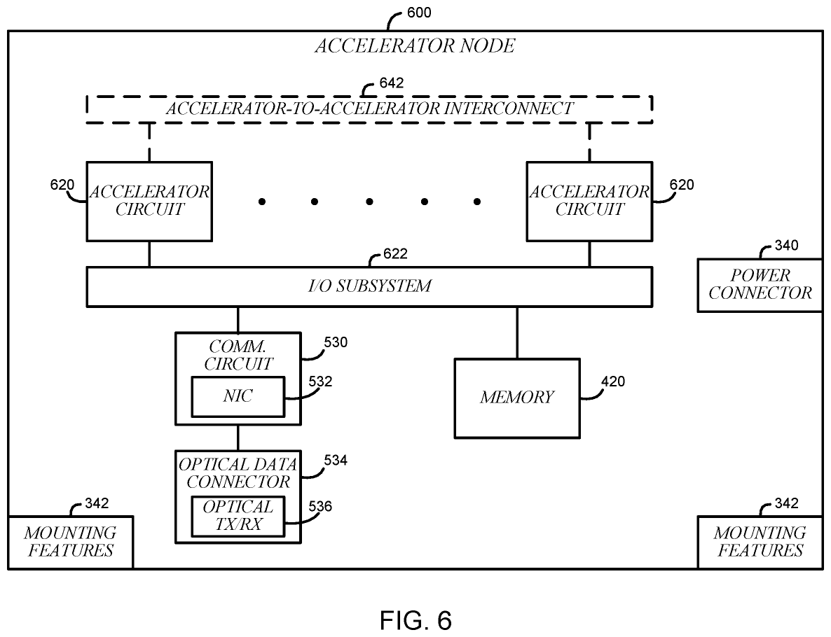

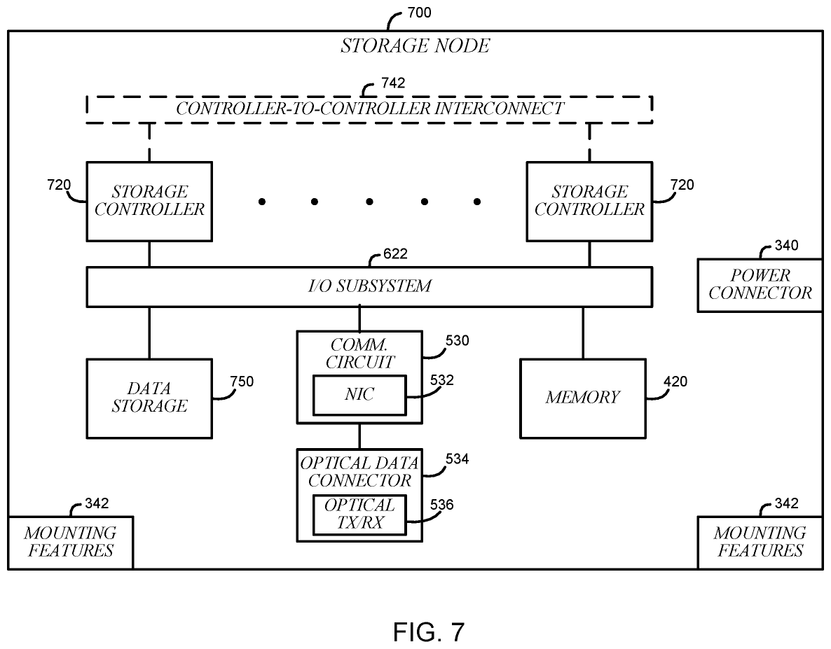

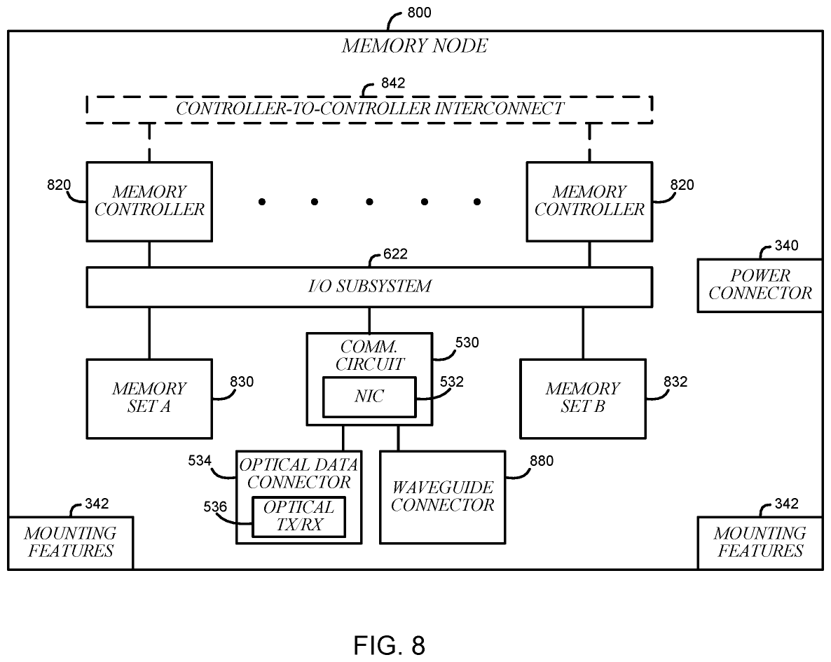

Referring now to FIG. 3, node 300, in the illustrative embodiment, is configured to be mounted in a corresponding rack 240 of the data center 100 as discussed above. In some embodiments, each node 300 may be optimized or otherwise configured for performing particular tasks, such as compute tasks, acceleration tasks, data storage tasks, etc. For example, the node 300 may be embodied as a compute node 500 as discussed below in regard to FIG. 5, an accelerator node 600 as discussed below in regard to FIG. 6, a storage node 700 as discussed below in regard to FIG. 7, or as a node optimized or otherwise configured to perform other specialized tasks, such as a memory node 800, discussed below in regard to FIG. 8. Each rack 240 may contain one or more nodes of a single or multiple node types—compute, storage, accelerator, memory, or others.

As discussed above, the illustrative node 300 includes a circuit board substrate 302, which supports various physical resources (for example, electrical components) mounted thereon.

As discussed above, the illustrative node 300 includes one or more physical resources 320 mounted to a top side 350 of the circuit board substrate 302. Although two physical resources 320 are shown in FIG. 3, it should be appreciated that the node 300 may include one, two, or more physical resources 320 in other embodiments. The physical resources 320 may be embodied as any type of processor, controller, or other compute circuit capable of performing various tasks such as compute functions and/or controlling the functions of the node 300 depending on, for example, the type or intended functionality of the node 300. For example, as discussed in more detail below, the physical resources 320 may be embodied as high-performance processors in embodiments in which the node 300 is embodied as a compute node, as accelerator co-processors or circuits in embodiments in which the node 300 is embodied as an accelerator node, storage controllers in embodiments in which the node 300 is embodied as a storage node, or a set of memory devices in embodiments in which the node 300 is embodied as a memory node.

The node 300 also includes one or more additional physical resources 330 mounted to the top side 350 of the circuit board substrate 302. In the illustrative embodiment, the additional physical resources include a network interface controller (NIC) as discussed in more detail below. Of course, depending on the type and functionality of the node 300, the physical resources 330 may include additional or other electrical components, circuits, and/or devices in other embodiments.

The physical resources 320 can be communicatively coupled to the physical resources 330 via an input/output (I/O) subsystem 322. The I/O subsystem 322 may be embodied as circuitry and/or components to facilitate input/output operations with the physical resources 320, the physical resources 330, and/or other components of the node 300. For example, the I/O subsystem 322 may be embodied as, or otherwise include, memory controller hubs, input/output control hubs, integrated sensor hubs, firmware devices, communication links (for example, point-to-point links, bus links, wires, cables, waveguides, light guides, printed circuit board traces, etc.), and/or other components and subsystems to facilitate the input/output operations.

In some embodiments, the node 300 may also include a resource-to-resource interconnect 324. The resource-to-resource interconnect 324 may be embodied as any type of communication interconnect capable of facilitating resource-to-resource communications. In the illustrative embodiment, the resource-to-resource interconnect 324 is embodied as a high-speed point-to-point interconnect (for example, faster than the I/O subsystem 322). For example, the resource-to-resource interconnect 324 may be embodied as a QuickPath Interconnect (QPI), an UltraPath Interconnect (UPI), PCI express (PCIe), or other high-speed point-to-point interconnect dedicated to resource-to-resource communications.

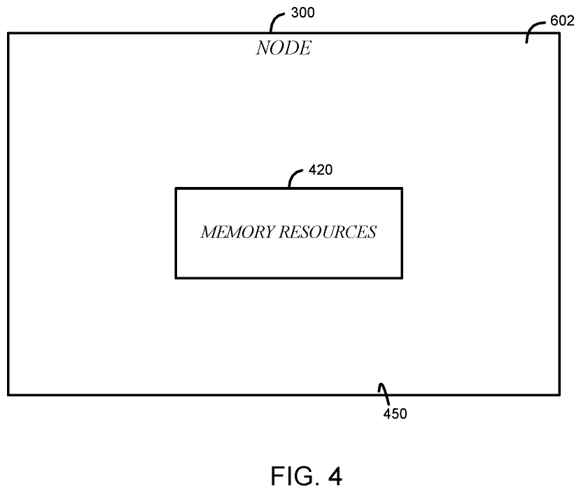

The node 300 also includes a power connector 340 configured to mate with a corresponding power connector of the rack 240 when the node 300 is mounted in the corresponding rack 240. The node 300 receives power from a power supply of the rack 240 via the power connector 340 to supply power to the various electrical components of the node 300. That is, the node 300 does not include any local power supply (for example, an on-board power supply) to provide power to the electrical components of the node 300. The exclusion of a local or on-board power supply facilitates the reduction in the overall footprint of the circuit board substrate 302, which may increase the thermal cooling characteristics of the various electrical components mounted on the circuit board substrate 302 as discussed above. In some embodiments, voltage regulators are placed on a bottom side 450 (see FIG. 4) of the circuit board substrate 302 directly opposite of the processors 520 (see FIG. 5), and power is routed from the voltage regulators to the processors 520 by vias extending through the circuit board substrate 302. Such a configuration provides an increased thermal budget, additional current and/or voltage, and better voltage control relative to typical printed circuit boards in which processor power is delivered from a voltage regulator, in part, by printed circuit traces.

In some embodiments, the node 300 may also include mounting features 342 configured to mate with a mounting arm, or other structure, of a robot to facilitate the placement of the node 300 in a rack 240 by the robot. The mounting features 342 may be embodied as any type of physical structures that allow the robot to grasp the node 300 without damaging the circuit board substrate 302 or the electrical components mounted thereto. For example, in some embodiments, the mounting features 342 may be embodied as non-conductive pads attached to the circuit board substrate 302. In other embodiments, the mounting features may be embodied as brackets, braces, or other similar structures attached to the circuit board substrate 302. The particular number, shape, size, and/or make-up of the mounting feature 342 may depend on the design of the robot configured to manage the node 300.

Referring now to FIG. 4, in addition to the physical resources 330 mounted on the top side 350 of the circuit board substrate 302, the node 300 also includes one or more memory devices 420 mounted to a bottom side 450 of the circuit board substrate 302. That is, the circuit board substrate 302 can be embodied as a double-sided circuit board. The physical resources 320 can be communicatively coupled to memory devices 420 via the I/O subsystem 322. For example, the physical resources 320 and the memory devices 420 may be communicatively coupled by one or more vias extending through the circuit board substrate 302. A physical resource 320 may be communicatively coupled to a different set of one or more memory devices 420 in some embodiments. Alternatively, in other embodiments, each physical resource 320 may be communicatively coupled to each memory device 420.

The memory devices 420 may be embodied as any type of memory device capable of storing data for the physical resources 320 during operation of the node 300, such as any type of volatile (for example, dynamic random access memory (DRAM), etc.) or non-volatile memory. Volatile memory may be a storage medium that requires power to maintain the state of data stored by the medium. Non-limiting examples of volatile memory may include various types of random access memory (RAM), such as dynamic random access memory (DRAM) or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces.

In one embodiment, the memory device is a block addressable memory device, such as those based on NAND or NOR technologies, for example, multi-threshold level NAND flash memory and NOR flash memory. A block can be any size such as but not limited to 2 KB, 4 KB, 5 KB, and so forth. A memory device may also include next-generation nonvolatile devices, such as Intel Optane® memory or other byte addressable write-in-place nonvolatile memory devices, for example, memory devices that use chalcogenide glass, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product. In some embodiments, the memory device may comprise a transistor-less stackable cross point architecture in which memory cells sit at the intersection of word lines and bit lines and are individually addressable and in which bit storage is based on a change in bulk resistance.

Referring now to FIG. 5, in some embodiments, the node 300 may be embodied as a compute node 500. The compute node 500 can be configured to perform compute tasks. Of course, as discussed above, the compute node 500 may rely on other nodes, such as acceleration nodes and/or storage nodes, to perform compute tasks.

In the illustrative compute node 500, the physical resources 320 are embodied as processors 520. Although only two processors 520 are shown in FIG. 5, it should be appreciated that the compute node 500 may include additional processors 520 in other embodiments. Illustratively, the processors 520 are embodied as high-performance processors 520 and may be configured to operate at a relatively high power rating.

In some embodiments, the compute node 500 may also include a processor-to-processor interconnect 542. Processor-to-processor interconnect 542 may be embodied as any type of communication interconnect capable of facilitating processor-to-processor interconnect 542 communications. In the illustrative embodiment, the processor-to-processor interconnect 542 is embodied as a high-speed point-to-point interconnect (for example, faster than the I/O subsystem 322). For example, the processor-to-processor interconnect 542 may be embodied as a QuickPath Interconnect (QPI), an UltraPath Interconnect (UPI), or other high-speed point-to-point interconnect dedicated to processor-to-processor communications (for example, PCIe or CXL).

The compute node 500 also includes a communication circuit 530. The illustrative communication circuit 530 includes a network interface controller (NIC) 532, which may also be referred to as a host fabric interface (HFI). The NIC 532 may be embodied as, or otherwise include, any type of integrated circuit, discrete circuits, controller chips, chipsets, add-in-boards, daughtercards, network interface cards, or other devices that may be used by the compute node 500 to connect with another compute device (for example, with other nodes 300). In some embodiments, the NIC 532 may be embodied as part of a system-on-a-chip (SoC) that includes one or more processors, or included on a multichip package that also contains one or more processors. In some embodiments, the NIC 532 may include a local processor (not shown) and/or a local memory (not shown) that are both local to the NIC 532. In such embodiments, the local processor of the NIC 532 may be capable of performing one or more of the functions of the processors 520. Additionally, or alternatively, in such embodiments, the local memory of the NIC 532 may be integrated into one or more components of the compute node at the board level, socket level, chip level, and/or other levels. In some examples, a network interface includes a network interface controller or a network interface card. In some examples, a network interface can include one or more of a network interface controller (NIC) 532, a host fabric interface (HFI), a host bus adapter (HBA), network interface connected to a bus or connection (for example, PCIe, CXL, DDR, and so forth). In some examples, a network interface can be part of a switch or a system-on-chip (SoC).

The communication circuit 530 is communicatively coupled to an optical data connector 534. The optical data connector 534 is configured to mate with a corresponding optical data connector of a rack when the compute node 500 is mounted in the rack. Illustratively, the optical data connector 534 includes a plurality of optical fibers which lead from a mating surface of the optical data connector 534 to an optical transceiver 536. The optical transceiver 536 is configured to convert incoming optical signals from the rack-side optical data connector to electrical signals and to convert electrical signals to outgoing optical signals to the rack-side optical data connector. Although shown as forming part of the optical data connector 534 in the illustrative embodiment, the optical transceiver 536 may form a portion of the communication circuit 530 or even processor 520 in other embodiments.

In some embodiments, the compute node 500 may also include an expansion connector 540. In such embodiments, the expansion connector 540 is configured to mate with a corresponding connector of an expansion circuit board substrate to provide additional physical resources to the compute node 500. The additional physical resources may be used, for example, by the processors 520 during operation of the compute node 500. The expansion circuit board substrate may be substantially similar to the circuit board substrate 302 discussed above and may include various electrical components mounted thereto. The particular electrical components mounted to the expansion circuit board substrate may depend on the intended functionality of the expansion circuit board substrate. For example, the expansion circuit board substrate may provide additional compute resources, memory resources, and/or storage resources. As such, the additional physical resources of the expansion circuit board substrate may include, but is not limited to, processors, memory devices, storage devices, and/or accelerator circuits including, for example, field programmable gate arrays (FPGA), application-specific integrated circuits (ASICs), security co-processors, graphics processing units (GPUs), machine learning circuits, or other specialized processors, controllers, devices, and/or circuits.

Referring now to FIG. 6, in some embodiments, the node 300 may be embodied as an accelerator node 600. The accelerator node 600 is configured to perform specialized compute tasks, such as machine learning, encryption, hashing, or other computational-intensive task. In some embodiments, for example, a compute node 500 may offload tasks to the accelerator node 600 during operation. The accelerator node 600 includes various components similar to components of the node 300 and/or compute node 500, which have been identified in FIG. 6 using the same reference numbers.

In the illustrative accelerator node 600, the physical resources 320 are embodied as accelerator circuits 620. Although only two accelerator circuits 620 are shown in FIG. 6, it should be appreciated that the accelerator node 600 may include additional accelerator circuits 620 in other embodiments. The accelerator circuits 620 may be embodied as any type of processor, co-processor, compute circuit, or other device capable of performing compute or processing operations. For example, the accelerator circuits 620 may be embodied as, for example, central processing units, cores, field programmable gate arrays (FPGA), application-specific integrated circuits (ASICs), programmable control logic (PCL), security co-processors, graphics processing units (GPUs), neuromorphic processor units, quantum computers, machine learning circuits, or other specialized processors, controllers, devices, and/or circuits.

In some embodiments, the accelerator node 600 may also include an accelerator-to-accelerator interconnect 642. Similar to the resource-to-resource interconnect 324 of the node 300 discussed above, the accelerator-to-accelerator interconnect 642 may be embodied as any type of communication interconnect capable of facilitating accelerator-to-accelerator communications. In the illustrative embodiment, the accelerator-to-accelerator interconnect 642 is embodied as a high-speed point-to-point interconnect (for example, faster than the I/O subsystem 622). For example, the accelerator-to-accelerator interconnect 642 may be embodied as a QuickPath Interconnect (QPI), an UltraPath Interconnect (UPI), or other high-speed point-to-point interconnect dedicated to processor-to-processor communications. In some embodiments, the accelerator circuits 620 may be daisy-chained with a primary accelerator circuit 620 connected to the NIC 532 and memory 420 through the I/O subsystem 322 and a secondary accelerator circuit 620 connected to the NIC 532 and memory 420 through a primary accelerator circuit 620.

Referring now to FIG. 7, in some embodiments, the node 300 may be embodied as a storage node 700. The storage node 700 is configured to store data in a data storage 750 local to the storage node 700. For example, during operation, a compute node 500 or an accelerator node 600 may store and retrieve data from the data storage 750 of the storage node 700. The storage node 700 includes various components similar to components of the node 300 and/or the compute node 500, which have been identified in FIG. 7 using the same reference numbers.

In the illustrative storage node 700, the physical resources 320 are embodied as storage controllers 720. Although only two storage controllers 720 are shown in FIG. 7, it should be appreciated that the storage node 700 may include additional storage controllers 720 in other embodiments. The storage controllers 720 may be embodied as any type of processor, controller, or control circuit capable of controlling the storage and retrieval of data into the data storage 750 based on requests received via the communication circuit 530. In the illustrative embodiment, the storage controllers 720 are embodied as relatively low-power processors or controllers. For example, in some embodiments, the storage controllers 720 may be configured to operate at a power rating of about 75 watts.

In some embodiments, the storage node 700 may also include a controller-to-controller interconnect 742. Similar to the resource-to-resource interconnect 324 of the node 300 discussed above, the controller-to-controller interconnect 742 may be embodied as any type of communication interconnect capable of facilitating controller-to-controller communications. In the illustrative embodiment, the controller-to-controller interconnect 742 is embodied as a high-speed point-to-point interconnect (for example, faster than the I/O subsystem 622). For example, the controller-to-controller interconnect 742 may be embodied as a QuickPath Interconnect (QPI), an UltraPath Interconnect (UPI), or other high-speed point-to-point interconnect dedicated to processor-to-processor communications.

Referring now to FIG. 8, in some embodiments, the node 300 may be embodied as a memory node 800. The memory node 800 is configured to provide other nodes 300 (for example, compute nodes 500, accelerator nodes 600, etc.) with access to a pool of memory (for example, in two or more sets 830, 832 of memory devices 420) local to the storage node 700. For example, during operation, a compute node 500 or an accelerator node 600 may remotely write to and/or read from one or more of the memory sets 830, 832 of the memory node 800 using a logical address space that maps to physical addresses in the memory sets 830, 832.

In the illustrative memory node 800, the physical resources 320 are embodied as memory controllers 820. Although only two memory controllers 820 are shown in FIG. 8, it should be appreciated that the memory node 800 may include additional memory controllers 820 in other embodiments. The memory controllers 820 may be embodied as any type of processor, controller, or control circuit capable of controlling the writing and reading of data into the memory sets 830, 832 based on requests received via the communication circuit 530. In the illustrative embodiment, each memory controller 820 is connected to a corresponding memory set 830, 832 to write to and read from memory devices 420 within the corresponding memory set 830, 832 and enforce any permissions (for example, read, write, etc.) associated with node 300 that has sent a request to the memory node 800 to perform a memory access operation (for example, read or write).

In some embodiments, the memory node 800 may also include a controller-to-controller interconnect 842. Similar to the resource-to-resource interconnect 324 of the node 300 discussed above, the controller-to-controller interconnect 842 may be embodied as any type of communication interconnect capable of facilitating controller-to-controller communications. In the illustrative embodiment, the controller-to-controller interconnect 842 is embodied as a high-speed point-to-point interconnect (for example, faster than the I/O subsystem 622). For example, the controller-to-controller interconnect 842 may be embodied as a QuickPath Interconnect (QPI), an UltraPath Interconnect (UPI), or other high-speed point-to-point interconnect dedicated to processor-to-processor communications. As such, in some embodiments, a memory controller 820 may access, through the controller-to-controller interconnect 842, memory that is within the memory set 832 associated with another memory controller 820. In some embodiments, a scalable memory controller is made of multiple smaller memory controllers, referred to herein as “chiplets”, on a memory node (for example, the memory node 800). The chiplets may be interconnected (for example, using EMIB (Embedded Multi-Die Interconnect Bridge)). The combined chiplet memory controller may scale up to a relatively large number of memory controllers and I/O ports, (for example, up to 16 memory channels). In some embodiments, the memory controllers 820 may implement a memory interleave (for example, one memory address is mapped to the memory set 830, the next memory address is mapped to the memory set 832, and the third address is mapped to the memory set 830, etc.). The interleaving may be managed within the memory controllers 820, or from CPU sockets (for example, of the compute node 500) across network links to the memory sets 830, 832, and may improve the latency associated with performing memory access operations as compared to accessing contiguous memory addresses from the same memory device.

Further, in some embodiments, the memory node 800 may be connected to one or more other nodes 300 (for example, in the same rack 240 or an adjacent rack 240) through a waveguide, using the waveguide connector 880. In the illustrative embodiment, the waveguides are 64 millimeter waveguides that provide 16. Rx (for example, receive) lanes and 16. Tx (for example, transmit) lanes. Each lane, in the illustrative embodiment, is either 16 GHz or 32 GHz. In other embodiments, the frequencies may be different. Using a waveguide may provide high throughput access to the memory pool (for example, the memory sets 830, 832) to another node (for example, a node 300 in the same rack 240 or an adjacent rack 240 as the memory node 800) without adding to the load on the optical data connector 534.

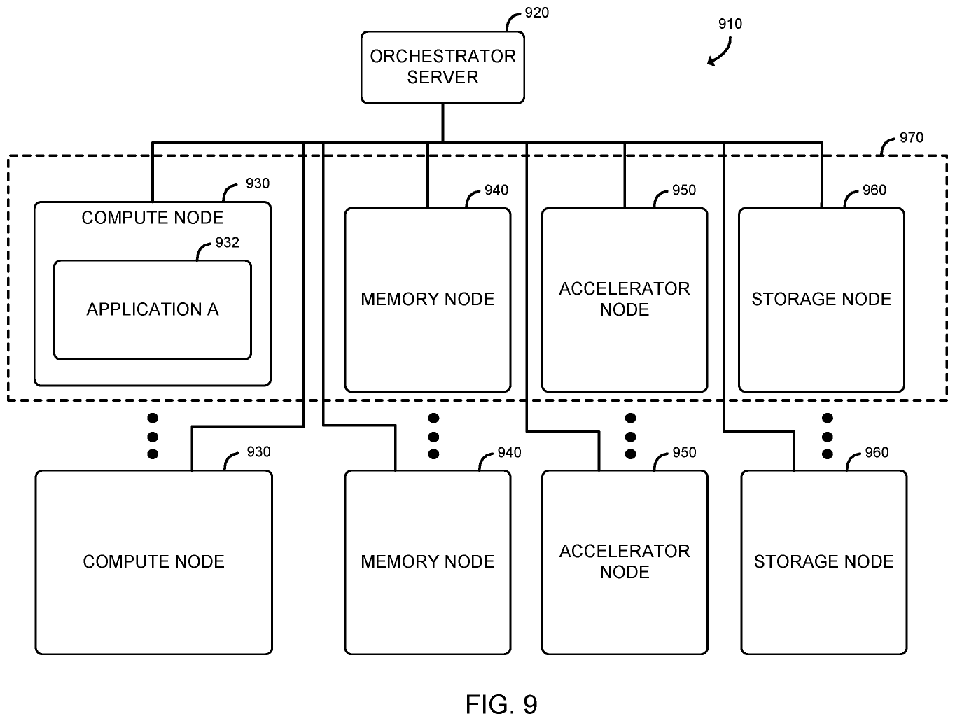

Referring now to FIG. 9, a system 910 for executing one or more workloads (for example, applications) may be implemented. In the illustrative embodiment, the system 910 includes an orchestrator server 920, which may be embodied as a managed node comprising a compute device (for example, a processor 520 on a compute node 500) executing management software (for example, a cloud operating environment, such as OpenStack) that is communicatively coupled to multiple nodes 300 including a large number of compute nodes 930 (for example, each similar to the compute node 500), memory nodes 940 (for example, each similar to the memory node 800), accelerator nodes 950 (for example, each similar to the accelerator node 600), and storage nodes 960 (for example, each similar to the storage node 700). One or more of the nodes 930, 940, 950, 960 may be grouped into a managed node 970, such as by the orchestrator server 920, to collectively perform a workload (for example, an application 932 executed in a virtual machine or in a container).

The managed node 970 may be embodied as an assembly of physical resources 320, such as processors 520, memory resources 420, accelerator circuits 620, or data storage 750, from the same or different nodes 300. Physical resources 320 from the same compute node 500 or the same memory node 800 or the same accelerator node 600 or the same storage node 700 can be assigned to a single managed node 970. Alternatively, physical resources 320 from the same node 300 can be assigned to different managed nodes 970. Further, the managed node may be established, defined, or “spun up” by the orchestrator server 920 at the time a workload is to be assigned to the managed node or at any other time, and may exist regardless of whether any workloads are presently assigned to the managed node. In the illustrative embodiment, the orchestrator server 920 may selectively allocate and/or deallocate physical resources 320 from the nodes 300 and/or add or remove one or more nodes 300 from the managed node 970 as a function of quality of service (QoS) targets (for example, a target throughput, a target latency, a target number of instructions per second, etc.) associated with a service level agreement for the workload (for example, the application 932). In doing so, the orchestrator server 920 may receive telemetry data indicative of performance conditions (for example, throughput, latency, instructions per second, etc.) in each node 300 of the managed node 970 and compare the telemetry data to the quality of service targets to determine whether the quality of service targets are being satisfied. The orchestrator server 920 may additionally determine whether one or more physical resources may be deallocated from the managed node 970 while still satisfying the QoS targets, thereby freeing up those physical resources for use in another managed node (for example, to execute a different workload). Alternatively, if the QoS targets are not presently satisfied, the orchestrator server 920 may determine to dynamically allocate additional physical resources to assist in the execution of the workload (for example, the application 932) while the workload is executing. Similarly, the orchestrator server 920 may determine to dynamically deallocate physical resources from a managed node if the orchestrator server 920 determines that deallocating the physical resource would result in QoS targets still being met.

Additionally, in some embodiments, the orchestrator server 920 may identify trends in the resource utilization of the workload (for example, the application 932), such as by identifying phases of execution (for example, time periods in which different operations, each having different resource utilizations characteristics, are performed) of the workload (for example, the application 932) and pre-emptively identifying available resources in the data center and allocating them to the managed node 970 (for example, within a predefined time period of the associated phase beginning). In some embodiments, the orchestrator server 920 may model performance based on various latencies and a distribution scheme to place workloads among compute nodes and other resources (for example, accelerator nodes, memory nodes, storage nodes) in the data center. For example, the orchestrator server 920 may utilize a model that accounts for the performance of resources on the nodes 300 (for example, FPGA performance, memory access latency, etc.) and the performance (for example, congestion, latency, bandwidth) of the path through the network to the resource (for example, FPGA). As such, the orchestrator server 920 may determine which resource(s) should be used with which workloads based on the total latency associated with each potential resource available in the data center 100 (for example, the latency associated with the performance of the resource itself in addition to the latency associated with the path through the network between the compute node executing the workload and the node 300 on which the resource is located).

In some embodiments, the orchestrator server 920 may generate a map of heat generation in the data center 100 using telemetry data (for example, temperatures, fan speeds, etc.) reported from the nodes 300 and allocate resources to managed nodes as a function of the map of heat generation and predicted heat generation associated with different workloads, to maintain a target temperature and heat distribution in the data center 100. Additionally or alternatively, in some embodiments, the orchestrator server 920 may organize received telemetry data into a hierarchical model that is indicative of a relationship between the managed nodes (for example, a spatial relationship such as the physical locations of the resources of the managed nodes within the data center 100 and/or a functional relationship, such as groupings of the managed nodes by the users the managed nodes provide services for, the types of functions typically performed by the managed nodes, managed nodes that typically share or exchange workloads among each other, etc.). Based on differences in the physical locations and resources in the managed nodes, a given workload may exhibit different resource utilizations (for example, cause a different internal temperature, use a different percentage of processor or memory capacity) across the resources of different managed nodes. The orchestrator server 920 may determine the differences based on the telemetry data stored in the hierarchical model and factor the differences into a prediction of future resource utilization of a workload if the workload is reassigned from one managed node to another managed node, to accurately balance resource utilization in the data center 100. In some embodiments, the orchestrator server 920 may identify patterns in resource utilization phases of the workloads and use the patterns to predict future resource utilization of the workloads.

To reduce the computational load on the orchestrator server 920 and the data transfer load on the network, in some embodiments, the orchestrator server 920 may send self-test information to the nodes 300 to enable each node 300 to locally (for example, on the node 300) determine whether telemetry data generated by the node 300 satisfies one or more conditions (for example, an available capacity that satisfies a predefined threshold, a temperature that satisfies a predefined threshold, etc.). Each node 300 may then report back a simplified result (for example, yes or no) to the orchestrator server 920, which the orchestrator server 920 may utilize in determining the allocation of resources to managed nodes.

An Infrastructure Processing Unit (IPU) is a programmable network device that intelligently manages system-level resources by securely accelerating networking and storage infrastructure functions in a data center. Systems can be composed differently based at least on how functions are mapped and offloaded.

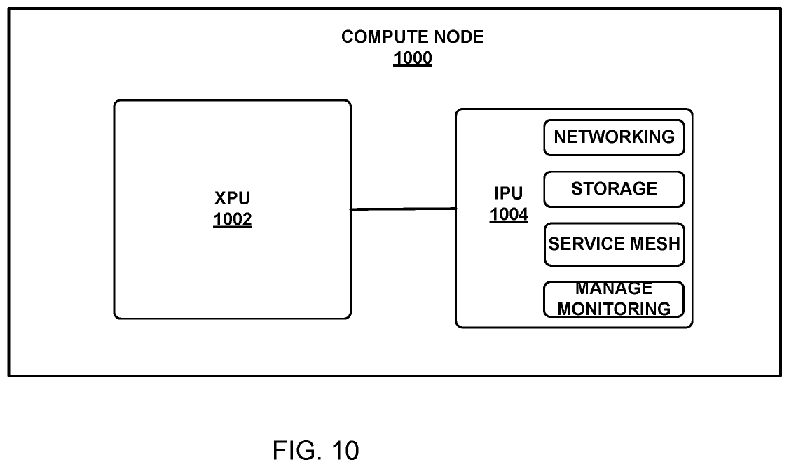

FIG. 10 illustrates a system that includes an IPU 1004 and an XPU 1002. Infrastructure Processing Units (IPUs) can be used by CSPs for performance, management, security and coordination functions in addition to infrastructure offload and communications. For example, IPUs can be integrated with smart NICs and storage or memory (for example, on a same die, system on chip (SoC), or connected dies) that are located at on-premises systems, base stations, gateways, neighborhood central offices, and so forth.

An IPU can perform an application composed of microservices. Microservices can include a decomposition of a monolithic application into small manageable defined services. Each microservice runs in its own process and communicates using protocols (for example, a Hypertext Transfer Protocol (HTTP) resource application programming interfaces (API), message service or Google remote procedure call (gRPC) calls/messages). Microservices can be independently deployed using centralized management of these services.

The IPU 1004 can execute platform management, networking stack processing operations, security (crypto) operations, storage software, identity and key management, telemetry, logging, monitoring and service mesh (for example, control how different microservices communicate with one another). The IPU 1004 can access the XPU 1002 to offload performance of various tasks. Resources managed by the IPU 1004 can include storage, memory etc. in addition to compute elements (for example, GPU, CPU).

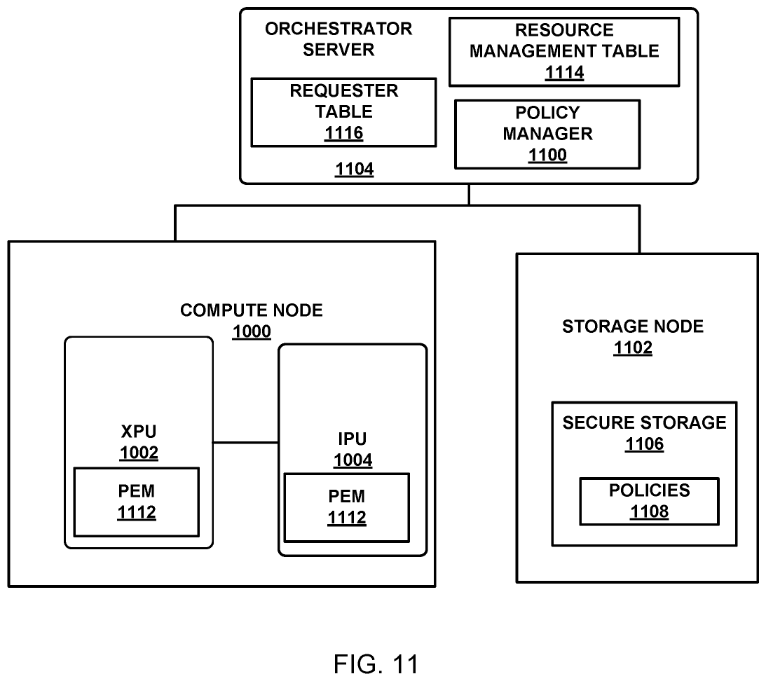

FIG. 11 is a simplified block diagram of a system that includes an orchestrator server 1104, a storage node 1102 and the compute node 1000 shown in FIG. 10.

The orchestrator server 1104 includes a policy manager 1100, resource management table 1114 and a requestor table 1116. The requestor table 1116 stores information about the resources that are allocated to the requestor. The storage node 1102 includes secure storage 1106 (a secure storage device, for example, a solid state drive or a non-volatile memory module) to store policies 1108.

A policy can be stored in the secure storage 1106 in the storage node 1102 using standard cryptographic algorithms such as a Hash-based Message Authentication Code (HMAC) that enforces integrity and authenticity of the stored policy. The Policy will typically not require confidentiality protection but if needed an Advanced Encryption Standard (AES) cryptographic algorithm can be applied before storing the policy in the secure storage 1106 in the storage node 1102.

The Cloud Service Provider's data center policies regarding use of data center resources are enforced at the resource level. The Cloud Service Provider dictates the policy, performs resource allocation according to the policies and then uses telemetry to obtain real time status of the data center, such as, network congestion, workload distribution, power consumption and others.

The orchestrator server 1104 receives requests from one or more applications, finds and allocates resources requested by one or more applications and maintains information regarding all resources (for example, CPUs, GPUs, memory and storage) in the data center including their availability and attributes (for example, compute capacity, memory size, security properties, etc.) in a resource management table 1114. Security properties can include Federal Information Processing Standards (FIPs) compliance, whether a Central Processing Unit (CPU) is capable of Confidential Computing, Security Version Number, and standard security algorithms support such as the Distributed Management Task Force (DMTF) Security Protocol and Data Model (SPDM) for attestation and key exchange

The policy manager 1100 is a trusted entity that is part of the orchestrator server 1104. The policy manager 1100 manages use of resources, policies 1108 and generates cryptographic tokens for an application that includes policy metadata. The policy manager 1100 the only entity that can securely access and modify the policies 1108 in secure storage 1106.

The policy manager 1100 executes in a trusted execution environment (for example, Intel® Software Guard Extensions (Intel® SGX), Arm® TrustZone®) in the orchestrator server 1104, generates a token (for example, a cryptographic message authentication code (MAC) that is unique and immutable using some randomness and is signed using the CSP's keys) and provides the token to the application (requestor) through a secure channel (e.g., SSL/TLS or similar standard). The application presents the token to the resource that the application has been assigned to use. The resource verifies the authenticity of the token that is, the token has been issued by the policy manager 1100, using the CSP's public key.

The policy manager 1100 allows use of the resource by the application per the policy metadata bound to the cryptographic token. Thus, the policy manager 1100 enforces the use of resources in the data center by authorized entities (for example, an application) and within the defined use policy.

The IPU 1004 in compute node 1000 provides an interface to the orchestrator server 1104 to discover resources in the data center. The IPU 1004 can query status of resources at any time. The IPU 1004 also performs resource management tasks requested by the orchestrator server 1104, for example, perform a reset of a resource or clear internal states of a resource.

The IPU 1004 includes a Policy Enforcement Module (PEM) (that can also be referred to as a Trusted Policy Enforcement Module) 1112. The Policy Enforcement Module 1112 verifies the cryptographic authorization token presented by an application and provides access to one or more resources based on successful verification of the token. The use of the resource is per the use policy that was cryptographically bound to the token by the Policy Manager. The Policy Enforcement Module 1112 in the IPU 1004 can be used to verify the token and provide access to one or more XPUs managed by the IPU 1004 or each XPU 1002 can include a Policy Enforcement Module 1112 that validates the token and provide use of the resource by the policy metadata tied to the token. The Policy Enforcement Module 1112 caches the policies and enforces the policies as and when applicable.

Policies 1108 that are stored in secure storage 1106 in storage node 1102 are selected by the Cloud Service Provider. The selection can be based on several factors such as the Service Level Agreement with the customer, CSP's goals for load balancing and power consumptions etc. The policies 1108 are securely accessed and securely modified only by the policy manager 1100. The policies 1108 include policies associated with a requestor (application), policies associated with a resource in the data center and policies associated with the data center. Policies 1108 are stored in a tamper proof way (using a cryptographic hash such that any modification to the policy by an unauthorized entity can be detected) in the secure storage 1106.

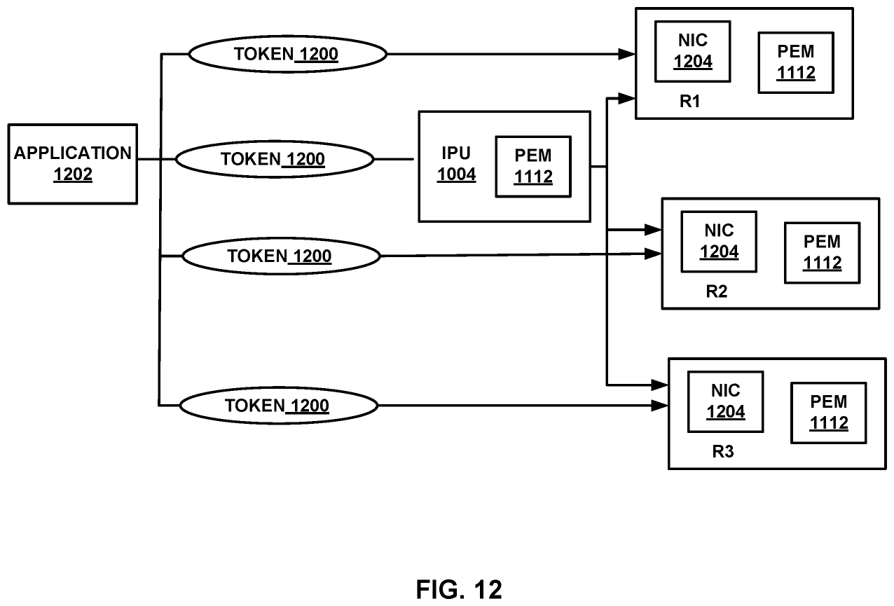

FIG. 12 illustrates an embodiment of a policy based mechanism that enforces use of compute resources in a data center by authorized entities.

An application (requester) 1202 presents the cryptographic token 1200 to the IPU 1004 to obtain access to the resources (for example, resources R1, R2, R3) assigned to the application 1202. The IPU 1004 verifies the cryptographic token 1200 and does not provide access to the resources R1, R2, R3 to the application 1202 if there is a token mismatch. Upon successful verification of the cryptographic token 1200, the IPU 1004 allows the application to access the resources R1, R2, R3. The application (requestor) 1202 uses the cryptographic token 1200 provided by the policy manager 1100 to communicate with compute resources (for example, resources R1, R2, R3).

Metadata included with the cryptographic token 1200 provide information regarding the compute resources (for example, R1, R2, R3) assigned to the application 1202. For example, the metadata can store an amount of storage, memory and xPU (for example, CPU, GPU) bandwidth that can be used by the application 1202. The metadata can also store a time period during which the application 1202 can use one or more compute resources, for example, a 24-hour time period.

The Policy Enforcement Module 1112 in the IPU 1004 verifies the cryptographic token 1200 and based on the metadata included with the token, 1200, allows the application to access the compute resources (for example, R1, R2, R2). The IPU 1004 performs control and management of the compute resources (for example, R1, R2, R3). Control messages such as configuring one or more compute resources (for example R1, R2, R3) can be performed by the IPU 1004.

Compute resources (for example R1, R2, R3) can also have a Policy Enforcement Module 1112 to verify the cryptographic token 1200 presented by the application 1202 and grant access to the compute resources (for example R1, R2, R3). The compute resources can include a Network Interface Controller (NIC) 1204 to allow the application 1202 to directly communicate with the resources (for example R1, R2, R3). For example, the application 1202 can directly transfer data to a compute resource (for example, memory) instead of through the IPU 1004 which can provide performance benefits.

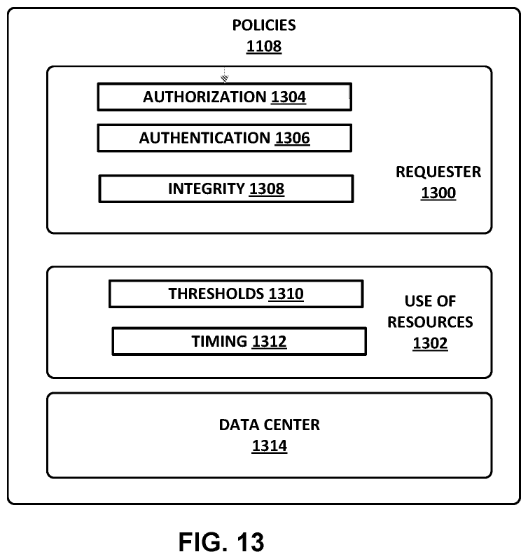

FIG. 13 illustrates types of policies that can be stored in policies 1108 in secure storage 1106.

The policies 1108 include policies associated with a requestor 1300, for example, one or more policies associated with a requestor (for example, an application) of compute resources. Policies associated with the requestor of compute resources include authorization 1304 (for example, is the requestor authorized to request the compute resources), which can be based on SLA, authentication 1306 (for example, the authentication that the requestor needs to present to obtain the compute resources) and integrity 1308 (for example, integrity requirements for the requestor, for example, does the requester need to present proof to indicate that the requestor's application has not been compromised. Cryptographic proof of an application's integrity can be in the form of a Software Guard Extensions (SGX) Quote provided by SGX or an Intel TDX (Trust Domain Extensions) Quote provided by Intel TDX attestation.

The policies 1108 include use of resources 1302, for example, one or more policies associated with the use of resources. Policies associated with resources include thresholds 1310 that are dynamically configurable based on workload, available resources and load balancing. Policies associated with resources also include timing 1312, for example a timing restriction for resource allocation to prevent hogging of an expensive/limited resource.

The policies 1108 include general data center policies 1314 to achieve goals for the CSP. The goals include load balancing, power profile and network congestion. The general data center policies 1314 enable the orchestrator server to manage resource allocation in a way that meets the CSP's load balancing needs and power and performance characteristics and allow equitable use of resources across the data center that meet the CSP's goals to maximize resource sharing and utilization. The general data center policies 1314 include polices to monitor which resources get heavily utilized and perform load balancing, measure network traffic and latency and monitor power and performance requirements.

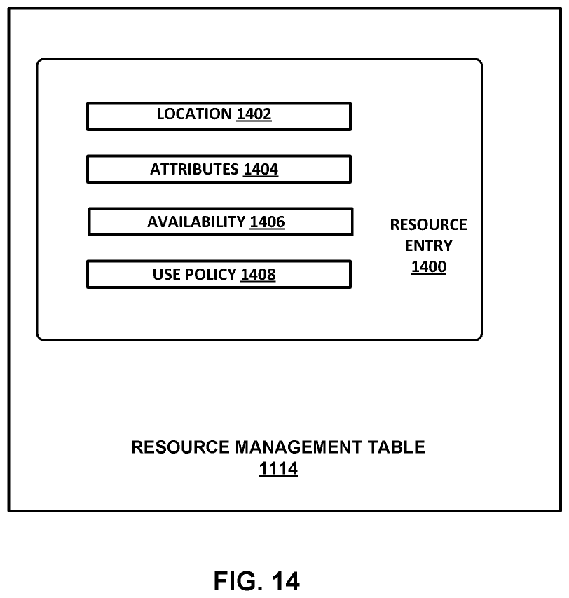

FIG. 14 is an example of the resource management table 1114 in the orchestrator server used by the policy manager 1100. The resource management table 1114 is a repository of resources available in the system.

The resource management table includes a resource entry 1400 for each compute resource including xPUs (CPU, GPU, FPGA, ASICs), storage and a shared memory pool. For each resource, the resource entry 1400 stores a location 1402 for the resource, for example an Internet Protocol (IP) Address for the resource).

The resource entry 1400 also stores attributes for the resource 1404. Attributes for the resource 1404 can include size, speed, and security compliance level.

The resource entry 1400 also stores availability 1406 of the resource and information about the resource use policy 1408 such as maximum allowed temperature, power consumption, max load allowed (for example, how many applications can run at the same time)

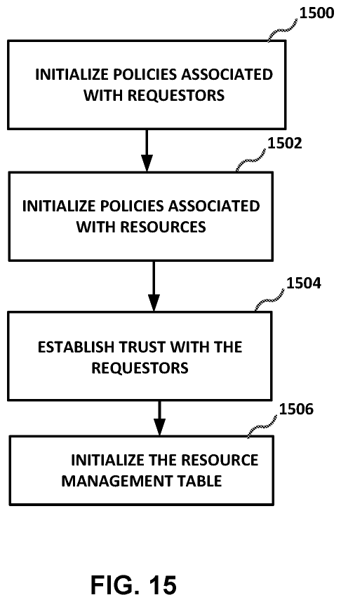

FIG. 15 is a flowgraph of a method performed by the policy owner (CSP) to initialize policies for requestors and resources in the system shown in FIG. 12. The policies can be static or dynamic policies.

At block 1500, the CSP via the policy manager 1100 in the orchestrator server 1104 initializes policies associated with a requestor 1300.

At block 1502, the CSP via the policy manager 1100 in the orchestrator server 1104 initializes policies associated with use of resources 1302.

At block 1504, the orchestrator server 1104 establishes trust with the resources and/or with the IPU 1004 that is managing the resources.

At block 1506, orchestrator server 1104 acquires information from the IPU 1004 in real time on available resources and the status of the available resources to initialize the resource management table 1114.

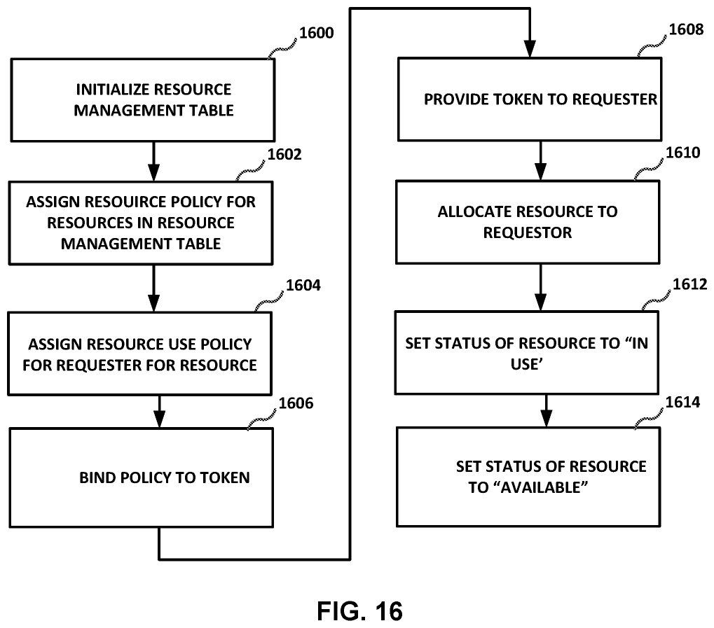

FIG. 16 is a flowgraph of a method performed to authenticate a requestor and assign a resource to the authenticated requestor.

At block 1600, the orchestrator server 1104 initializes the resource management table 1114 by communicating with all the servers or IPUs and getting information about the resources available across the data center.

At block 1602, the policy manager 1100 within the orchestrator server 1104 defines the resource policy for the resources in the resource management table 1114. Examples of resource use policy include maximum power consumption threshold and maximum speed of a compute unit. Alternately, the resource policy can be communicated by the server or IPU 1004 to the orchestrator server 1104.

At block 1604, upon receiving a request for a resource, the orchestrator server 1104 locates a resource in the resource management table and assigns the resource use policy for the requestor with regards to the resource. The resource use policy is based on the SLA with the requestor and resource policy and CSP's goals for the data center (for example, power consumption, performance, resource utilization, and congestion). The orchestrator server 1104 also locates the requester in the requestor table 1116 to verify how many resources are already allocated to the requestor and if the number of allocated resources is within the SLA with the requestor.

At block 1606, the orchestrator server 1104 generates a cryptographic token signed by the CSP's private key and cryptographically binds the policy information to the token using an algorithm such as a cryptographic MAC.

At block 1608, the orchestrator server 1104 provides the cryptographic token to the requestor along with other information about the resource such as the resource's IP address, supported features, and communication protocol to communicate with the resource. The orchestrator server 1104 also updates availability 1406 in the resource entry 1400 in the resource management table 1114 to mark the resource as ‘assigned’.

At block 1610, the requestor communicates with the resource via the IPU 1004 and presents the resource use token. The Policy Enforcement Module (PEM) in the IPU 1004 verifies the token, extracts the resource use policy 1408 from the resource entry 1400, and allocates the resource to the requestor within the constraints of the resource use policy 1408 extracted for the resource.

At block 1612, the IPU 1004 communicates with the orchestrator server 1104 and informs the orchestrator server 1104 that the resource has been allocated and is in use. The orchestrator server 1104 updates availability 1406 in the resource entry 1400 in the resource management table 1114 to change the status of the resource from ‘assigned’ to ‘in use’.

At block 1614, when the requestor no longer needs the resource or the requester is evicted to comply with the use policy (for example, the policy may be that the requestor can use the resource only for certain amount of time), the IPU 1004 informs the orchestrator server 1104 that the resource is free. The orchestrator server 1104 updates availability 1406 in the resource entry 1400 in the resource management table 1114 to indicate that the resource is available.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A non-transitory machine-readable storage medium can cause a machine to perform the functions or operations described, and includes any mechanism that stores information in a form accessible by a machine (for example, computing device, electronic system, etc.), such as recordable/non-recordable media (for example, read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (for example, application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope.

Therefore, the illustrations and examples herein should be construed in an illustrative, and not a restrictive sense. The scope of the invention should be measured solely by reference to the claims that follow.

### EXAMPLES

Illustrative examples of the technologies disclosed herein are provided below. An embodiment of the technologies may include any one or more, and any combination of, the examples described below.

Example 1 is a data center including a plurality of compute resources; a storage device to store first policies associated with a requester of the plurality of compute resources and second policies associated with the plurality of compute resources; and an orchestrator server in communication with the plurality of compute resources, the orchestrator server comprising a policy manager to use the first polices and the second polices to enforce use of the plurality of compute resources in the data center by authorized entities.

Example 2 includes the data center of Example 1, wherein the policy manager to execute in a trusted execution environment, generate a token for a requester of one or more compute resources and provide the token to a compute resource assigned to the requester.

Example 3 includes the data center of any of Examples 1 and 2, wherein the storage device to store third policies associated with the data center.

Example 4 includes the data center of any of Examples 1-3, wherein the first policies include authorization.

Example 5 includes the data center of any of Examples 1-4, wherein the second polices include a timing restriction for resource allocation.

Example 6 includes the data center of any of Examples 1-5, wherein the storage device is a secure storage device.

Example 7 includes the data center of any of Examples 1-6, wherein the third policies include measure network traffic and latency.

Example 8 is a method comprising: storing, in a storage device, first policies associated with a requester of a plurality of compute resources and second policies associated with the plurality of compute resources; and using, by a policy manager in an orchestrator server, the first polices and the second polices to enforce use of the plurality of compute resources in a data center by authorized entities.

Example 9 includes the method of Example 8 wherein the policy manager to execute in a trusted execution environment, generate a token for a requester of one or more compute resources and provide the token to a compute resource assigned to the requester.

Example 10 includes the method of any of Examples 8 and 9 wherein the storage device to store third policies associated with the data center.

Example 11 includes the method of any of Examples 8-10, wherein the first policies include authorization.

Example 12 includes the method of any of Examples 8-11, wherein the second polices include a timing restriction for resource allocation.

Example 13 includes the method of any of Examples 8-1, wherein the storage device is a secure storage device.

Example 14 includes the method of any of Examples 8-13, wherein the third policies include measure network traffic and latency.

Example 15 is a server comprising a plurality of compute resources; a storage device to store first policies associated with a requester of the plurality of compute resources and second policies associated with the plurality of compute resources; and one or more non-transitory machine-readable storage media comprising a plurality of instructions stored thereon that, in response to being executed, cause the server to: use the first polices and the second polices to enforce use of the plurality of compute resources in the server by authorized entities.

Example 16 includes the server of Example 15, wherein plurality of instructions to execute in a trusted execution environment, generate a token for a requester of one or more compute resources and provide the token to a compute resource assigned to the requester.

Example 17 includes the server of any of Examples 15 and 16, wherein the storage device to store third policies associated with the server.

Example 18 includes the server of any of Examples 15-17, wherein the first policies include authorization.

Example 19 includes the server of any of Examples 15-18, wherein the second polices include a timing restriction for resource allocation.

Example 20 includes the server of any of Examples 15-19, wherein the storage device is a secure storage device.

Example 21 includes the server of any of Examples 15-20, wherein the third policies include measure network traffic and latency.

Example 27 is a data center that includes means for performing the method of any one of Examples 8 to 14.

Example 28 is a non-transitory machine readable medium comprising a plurality of instructions that in response to being executed by a system cause the system to carry out a method according to any one of claims 9 to 14.

1. A data center comprising:
a plurality of compute resources;
a storage device to store first policies associated with a requester of the plurality of compute resources and second policies associated with the plurality of compute resources; and
an orchestrator server in communication with the plurality of compute resources, the orchestrator server comprising a policy manager to use the first polices and the second polices to enforce use of the plurality of compute resources in the data center by authorized entities.

2. The data center of claim 1, wherein the policy manager to execute in a trusted execution environment, generate a token for a requester of one or more compute resources and provide the token to a compute resource assigned to the requester.

3. The data center of claim 1, wherein the storage device to store third policies associated with the data center.

4. The data center of claim 1, wherein the first policies include authorization.

5. The data center of claim 1, wherein the second polices include a timing restriction for resource allocation.

6. The data center of claim 1, wherein the storage device is a secure storage device.

7. The data center of claim 3, wherein the third policies include measure network traffic and latency.

8. A method comprising:
storing, in a storage device, first policies associated with a requester of a plurality of compute resources and second policies associated with the plurality of compute resources; and
using, by a policy manager in an orchestrator server, the first polices and the second polices to enforce use of the plurality of compute resources in a data center by authorized entities.

9. The method of claim 8, wherein the policy manager to execute in a trusted execution environment, generate a token for a requester of one or more compute resources and provide the token to a compute resource assigned to the requester.

10. The method of claim 8, wherein the storage device to store third policies associated with the data center.

11. The method of claim 8, wherein the first policies include authorization.

12. The method of claim 8, wherein the second polices include a timing restriction for resource allocation.

13. The method of claim 8, wherein the storage device is a secure storage device.

14. The method of claim 10, wherein the third policies include measure network traffic and latency.

15. A server comprising:
a plurality of compute resources;
a storage device to store first policies associated with a requester of the plurality of compute resources and second policies associated with the plurality of compute resources; and
one or more non-transitory machine-readable storage media comprising a plurality of instructions stored thereon that, in response to being executed, cause the server to:
use the first polices and the second polices to enforce use of the plurality of compute resources in the server by authorized entities.

16. The server of claim 15, wherein plurality of instructions to execute in a trusted execution environment, generate a token for a requester of one or more compute resources and provide the token to a compute resource assigned to the requester.

17. The server of claim 15, wherein the storage device to store third policies associated with the server.

18. The server of claim 15, wherein the first policies include authorization.

19. The server of claim 15, wherein the second polices include a timing restriction for resource allocation.

20. The server of claim 15, wherein the storage device is a secure storage device.

21. The server of claim 17, wherein the third policies include measure network traffic and latency.
